(19) United States
(12) Patent Application Publication
(10) Pub. No.: US 2013/0309623 A1
(43) Pub. Date: Nov. 21, 2013

(54) SINTERING CHAMBER STRUCTURE

(71) Applicants: CHENG-YU CHOU, New Taipei City (TW); CHIH-WEI CHENG, New Taipei City (TW)

(72) Inventors: CHENG-YU CHOU, New Taipei City (TW); CHIH-WEI CHENG, New Taipei City (TW)

(73) Assignee: Cheng Uei Precision Industry Co., LTD., New Taipei City (TW)

(21) Appl. No.: 13/473,592

(22) Filed: May 17, 2012

(51) Int. Cl. F27D 5/00

(52) U.S. Cl. 432/253

(57) ABSTRACT

A sintering chamber structure adapted to store multiple articles to be sintered in a sintering furnace, includes a first wall, a second wall, two side walls interconnecting the first and second walls, at least two supporting walls, and holding boards for holding the multiple articles. The two side walls and the first and second walls together define a storage space communicating outside. The two supporting walls correspondingly form a plurality of guiding grooves, wherein the first and second walls correspondingly form a pair of positioning slots communicating with the storage space, the at least two supporting walls are detachably inserted in the pairs of positioning slots, respectively, and the holding boards are inserted in corresponding guiding grooves. In this manner, the at least two supporting walls can adjust the inner space according to the sizes of the articles, whereby achieving the best yield of sintering.

### BACKGROUND OF THE INVENTION

1. Field of the Invention

The present invention relates to a sintering chamber structure, and particularly to a sintering chamber structure having a detachable structure and being capable of effectively utilizing an internal space of the sintering chamber.

2. Related Art

Metal Powder Injection Molding (MIM) is a new metalworking process utilizing plastic injection molding, polymer and flowable raw material for injection, in combination with powder metallurgy and metal material science. MIM is performed by utilizing finely-powdered metal combined with a measured amount of binder material to produce the raw material (referred to as the feedstock) through mixing and granulating. The feedstock is injected under liquid status into a precise mold by using plastic injection molding machines to form a green part. The green part must have been undergone a process of partially vacuum de-binding to remove a portion of the binder material from the metal. Then the green part will be sintered to become a brown part which can also be performed with secondary processes of heat-treatment, machining or surface treatment to become a high-density and high-precision metal part of more complex shapes and fine details. However, most metal parts are not preferable for being machined, and they can be only processed with the heat-treatment, polishing, or electroplating. Metal parts produced by the MIM process have advantages of complex shapes, minimized size, balanced material properties, good mechanical properties, and thin walls. As a result, MIM can excel at cost management and product precision in comparison with traditional powder metallurgy, machining, pressure casting, and precise casting.

Generally, the MIM process consists of steps of injecting the feedstock into a mold cavity with an injection molding machine; removing wax material using solvents or thermal furnaces; sintering the green part to remove all the other binder material with a sintering furnace so as to compact the metal powder. In the above-mentioned steps, sintering of the sintering furnace is one of the major factors to determine production quantity and efficiency.

A traditional sintering furnace includes a sintering cavity surrounded by multiple heating elements. The sintering cavity is provided with a plurality of slabs parallel disposed and spaced horizontally for holding articles (the green part) thereon to be sintered. Specifically, a traditional sintering cavity has an upper wall, a lower wall and two side walls interconnecting and fixedly disposed between the upper and lower walls, wherein the two side walls are formed with a plurality of spaced slits from vertically for the insertion of the slabs, whereby forming a layer structure.

Because the two side walls of the traditional sintering cavity are fixedly disposed, the sintering cavity is not allowed to change the intervals between the slabs for storing articles of different sizes at a time. In other words, the intervals between the slabs may too small to be applied to large articles, while too large intervals for small articles seems to be wasted on the space, and both instances cause waste of internal space of the sintering cavity. Thus it is hard for a traditional sintering cavity to be sintered in the productive volume and improve yield rate. Although a sintering cavity can be specifically designed to form various intervals of the slabs matching different sizes of articles, it takes considerable time and cost for a productive department to change production lines regularly.

### SUMMARY OF THE INVENTION

Accordingly, an object of the present invention is to provide a sintering chamber structure having a detachable structure intended to provide appropriate room for storing different sizes of articles so as to effectively adjust an internal space of a sintering chamber, and achieve the productive volume of sintering.

To achieve the above-mentioned objects, the sintering chamber structure comprises: a first wall; a second wall parallel disposed opposite to the first wall; two side walls spaced away from each other and interconnecting the first and second walls, the two side walls and the first and second walls cooperatively defining a storage space communicating outside; at least two supporting walls detachably disposed in the storage space and located parallel to each other, the two supporting walls correspondingly forming a plurality of guiding grooves; and a plurality of holding boards intended for holding the multiple articles; wherein the first and second walls correspondingly form a pair of positioning slots communicating with the storage space, the at least two supporting walls are detachably inserted in the pairs of positioning slots from one side of the storage space, respectively, and the plurality of holding boards are inserted in corresponding guiding grooves.

With the above-mentioned structure, the at least two supporting walls are removable to be replaced by other supporting walls having the guiding grooves spaced in a suitable distance for storing the articles, so as to effectively use an internal space of the sintering chamber structure.

### BRIEF DESCRIPTION OF THE DRAWINGS

FIG. 1 is a partially exploded perspective view of a sintering chamber structure a first embodiment of the present invention.

FIG. 2 is an assembled perspective view of FIG. 1.

FIG. 3 is an assembled perspective view of a second embodiment of the present invention, without assembly of a plurality of holding boards.

FIG. 4 is an assembled perspective view of a third embodiment of the present invention, without assembly of the plurality of holding boards.

FIG. 5 is an assembled perspective view of FIG. 4.

### DESCRIPTION OF THE PREFERRED EMBODIMENTS

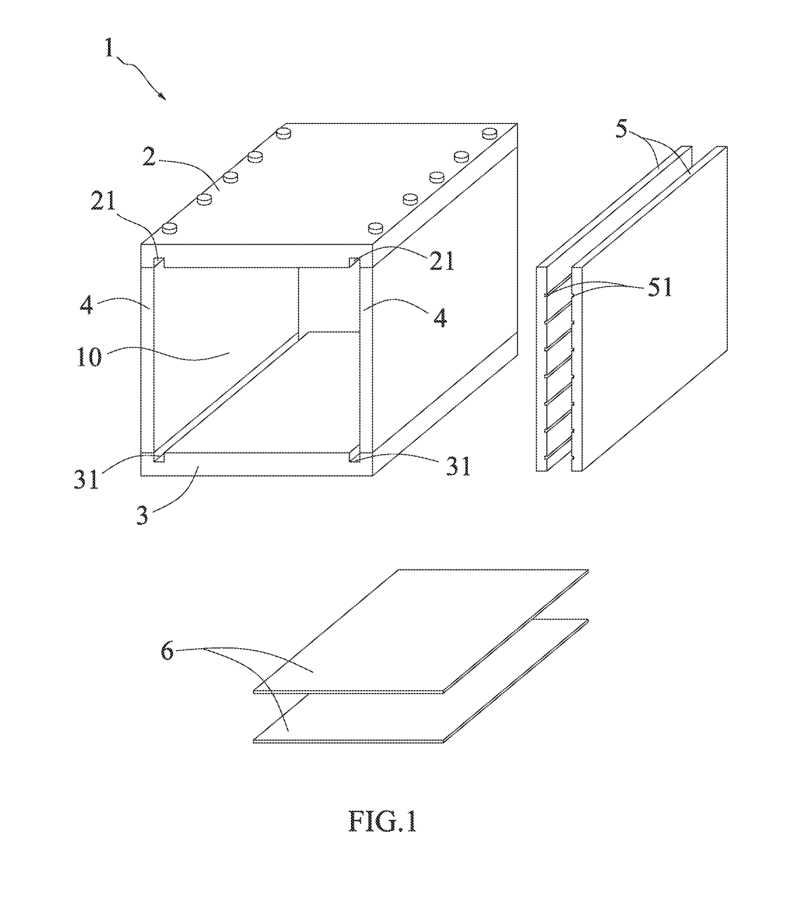

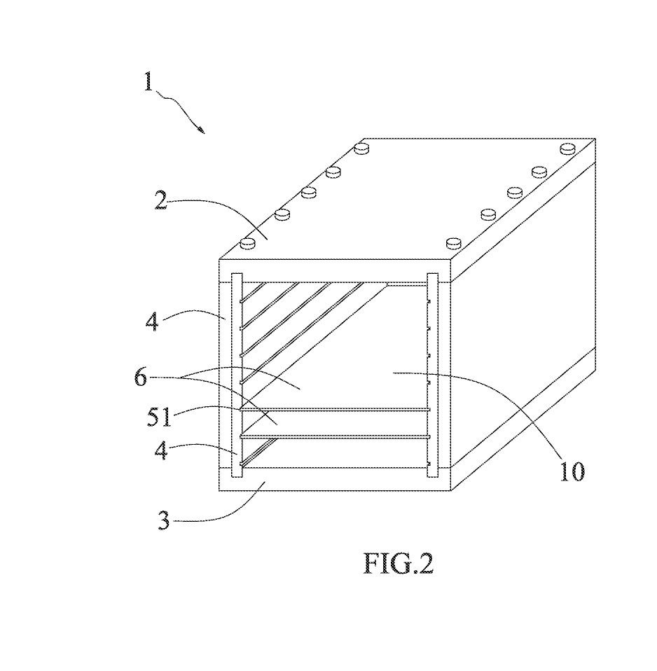

Referring to FIGS. 1 and 2 illustrating a first embodiment of a sintering chamber structure 1 in accordance with the present invention, the sintering chamber structure 1 adapted to store multiple articles (not shown) for being sintered in a sintering furnace (not shown), comprises a first wall, 2, a second wall 3, two side walls 4, a plurality of supporting walls 5, and a plurality of holding boards 6. The first and second walls 2, 3 are disposed opposite to each other horizontally. The two side walls 4 are spaced away vertically each other and interconnect the first and second walls 2. 3 at the end of opposite sides respectively. The two side walls 4 and the first and second walls 2, 3 together define a storage space 10 for communicating outside. The two side walls 4 can be combined with the first and second walls 2, 3 by screws.

Referring to FIGS. 1 and 2, a pair of positioning slots 21 are formed inwardly at the inner surface of the first wall 2, facing the storage space 10, and spaced away from each other for adjoining the two side walls 4, respectively. A pair of positioning slots 31 are formed inwardly at the inner surface of the second wall 3, wherein the positioning slots 21, 31 are parallel formed and face each other. Both of the positioning slots 21, 31 adjoin the storage space 10.

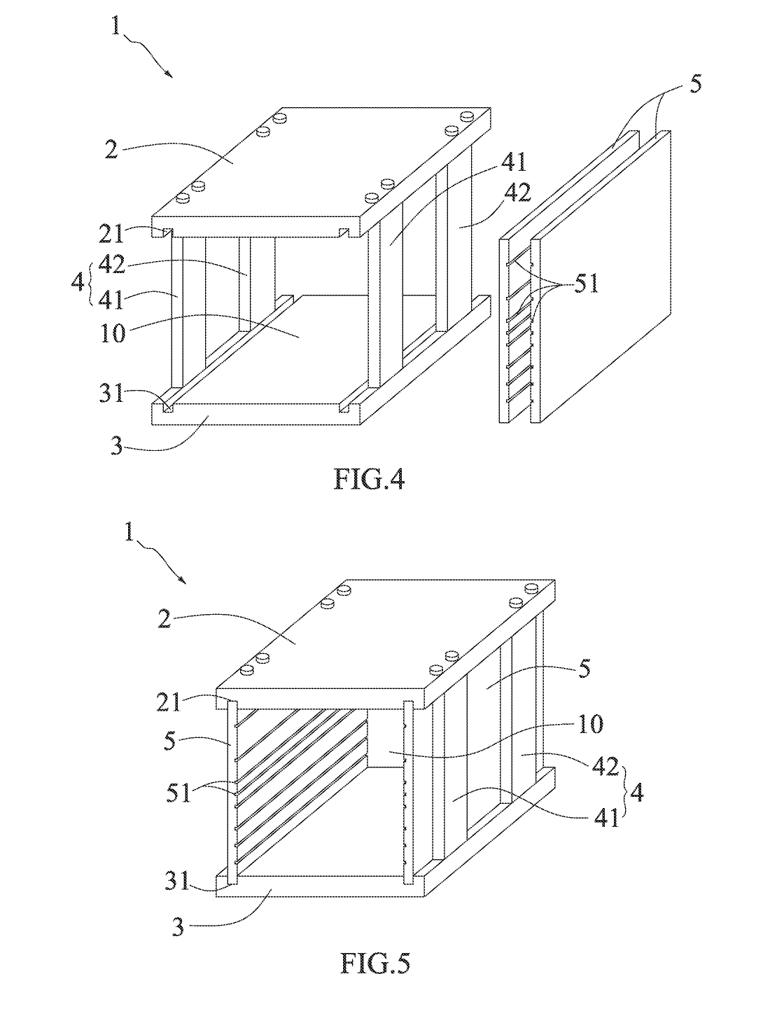

A pair of supporting walls 5 defines a plurality of guiding grooves 51 respectively which can be disposed in the storage space 10 in pair, wherein the guiding grooves 51 concave the supporting walls 5 inwardly and communicate the storage space 10. In this preferable embodiment, the guiding grooves 51 are spaced in parallel with each other at an equal distance and penetrate opposite ends of the supporting wall 5 (as shown in FIG. 1). Alternatively, the guiding grooves 51 are capable of being spaced in parallel with each other at different intervals (as shown in FIG. 4). In other words, the sintering chamber structure 1 of the present invention is provided with various pairs of guiding grooves by the supporting walls 5. Each pair of the guiding grooves 51 spaced apart from each other in an interval that may be different distances.

Referring to FIG. 2, the two supporting walls 5 are detachably inserted in the pairs of positioning slots 21, 31 from one side of the storage space 10, respectively, wherein the opposite sides of each of the two supporting walls 5 can be inserted in the positioning slots 21, 31, respectively. Furthermore, one surface of the supporting wall 5 opposite to the guiding grooves 51 is located adjacent to respective side wall 4. Each of the holding boards 6 can be inserted into corresponding guiding groove 51 with opposite ends of the holding board 6. The plurality of holding boards 6 are used for holding the multiple articles thereon.

Particularly, according to different sizes of the multiple articles, the two supporting walls 5 of the sintering chamber structure 1 having the guiding grooves 51 spaced at pairs correspondingly, so as to effectively partitioning an internal space of the sintering chamber structure 1. Furthermore, the sintering chamber structure 1 is made of graphite or metal material so in order to be sintered by the sintering furnace at a temperature over a thousand degrees Celsius.

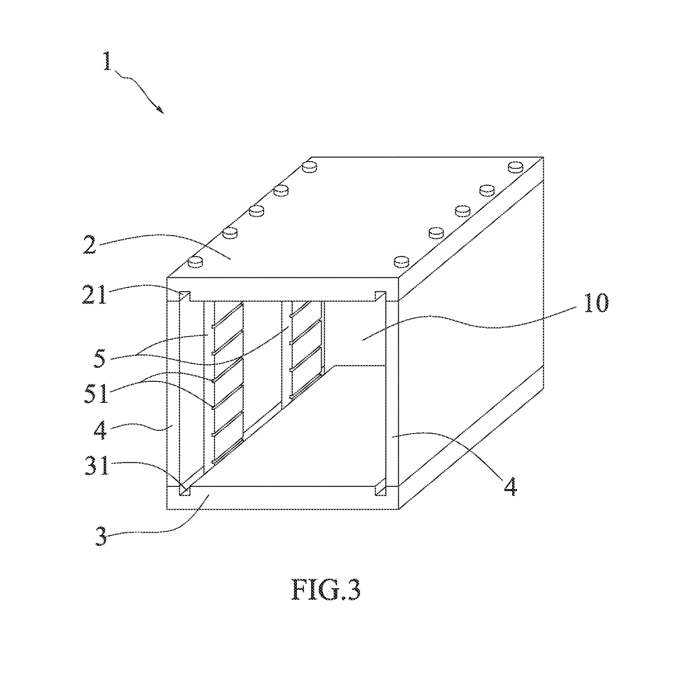

Further referring to FIG. 3 illustrating a second embodiment of the present invention, in consideration of the cost management, the supporting wall 5 is capable of being exemplified in several separate parts, which are spaced apart from each other. Each separate part of the supporting wall 5 is provided with the plurality of guiding grooves 51 corresponding to other parts of the supporting wall 5. In this manner, the plurality of holding boards 6 can be inserted in corresponding guiding grooves 51 of the separate parts, whereby the supporting wall 5 can be reduced in size by dividing the internal space into parts so as to lower the cost of manufacturing.

Referring to FIGS. 4 and 5 illustrating a third embodiment of the present invention, the first and second embodiments as mentioned above are known as enclosed structure, that is, each of the two side walls 4 connect the first and second walls 2, 3 and enclose the storage space 10 in a manner such that two opposite ends of each of the side walls 4 are flush with two opposite ends of the first and second walls 2, 3. In the third embodiment, each of the two side walls 4 consists of a plurality of partitions 41, 42 spaced from each other. Likewise, the two side walls 4 in this embodiment are exemplified by the separate partitions 41, 42. Therefore, a total size of the partitions 41, 42 are smaller than the side walls 4 of the first and second embodiments, whereby the cost of manufacturing the side wall 4 can be effectively reduced. Furthermore, the partitions 41, 42 are capable of forming a half enclosed structure with the supporting wall 5.

Accordingly, the sintering chamber structure 1 of the present invention utilizes the positioning slots 21, 31 of the first and second walls 2, 3 to allow the supporting walls 5 to be detachably disposed thereon, so as to make a quick adjustment operation of the supporting walls 5 according to the sizes of the articles, and further achieve the purpose of the highest volume of sintering and greatly improve a production rate.

It is understood that the invention may be embodied in other forms within the scope of the claims. Thus the present examples and embodiments are to be considered in all respects as illustrative, and not restrictive, of the invention defined by the claims.

What is claimed is:

1. A sintering chamber structure adapted to store multiple articles to be sintered in a sintering furnace, comprising:
a first wall;
a second wall disposed parallel opposite to the first wall;
two side walls spaced away from each other and interconnecting the first and second walls, the two side walls and the first and second walls together defining a storage space communicating outside;
at least two supporting walls detachably disposed in the storage space and located parallel opposite to each other, the two supporting walls correspondingly forming a plurality of guiding grooves; and
a plurality of holding boards for holding articles;
wherein the first and second walls correspondingly form a pair of positioning slots communicating with the storage space, the at least two supporting walls are detachably inserted in the positioning slots from one side of the storage space, respectively, and the plurality of holding boards are inserted in corresponding guiding grooves.

2. The sintering chamber structure of claim 1, wherein each of the pairs of positioning slots of the first and second walls adjoin the side walls, respectively.

3. The sintering chamber structure of claim 1, wherein the plurality of guiding grooves are spaced in parallel with each other.

4. The sintering chamber structure of claim 1, wherein each of the two side walls consists of a plurality of partitions spaced apart from each other.

5. The sintering chamber structure of claim 1, wherein a plurality of the supporting walls are inserted in corresponding positioning slots.

6. The sintering chamber structure of claim 1, wherein each of the pairs of positioning slots concaves inwardly of the first and second walls, and the plurality of guiding grooves concave inwardly of the at least two supporting walls, respectively.

7. The sintering chamber structure of claim 1, wherein the sintering chamber structure is made of graphite or metal material.
